(19) United States
(12) Patent Application Publication
(10) Pub. No.: US 2009/0097178 A1
(43) Pub. Date: Apr. 16, 2009

(54) METHODS AND APPARATUS TO DETECT AND OVER-CURRENT IN SWITCHING CIRCUITS

(75) Inventors: Jagadeesh Krishnan, Dallas, TX (US); Angelo W. Pereira, Dallas, TX (US); Rajkumar Jayaraman, Plano, TX (US); Paul H. Fontaine, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/871,691

(22) Filed: Oct. 12, 2007

(51) Int. Cl. H02H 3/08

(52) U.S. Cl. 361/86

(57) ABSTRACT

Methods and apparatus to detect an over-current in switching circuits are described. An example method to detect an over-current in a switching circuit includes randomly selecting a sensor from a plurality of sensors operatively coupled to an output stage of the switching circuit; detecting a first voltage via the randomly selected sensor; and comparing the first voltage to a reference voltage to generate a signal, wherein the signal indicates a status of the output stage of the switching circuit.

### TECHNICAL FIELD

The present disclosure relates generally to circuits and, more particularly, to methods and apparatus to detect an over-current in a switching circuit.

### BACKGROUND

Electronic components often have a limited current capacity and may become damaged or disabled upon an excessive current flow. Thus, certain electronic devices often include an over-current protection mechanism. An over-current protection mechanism may detect, for example, a short-circuit at an output or any other large current demands capable of damaging circuit components (e.g., power field-effect transistors (FETs)). Upon detecting such a condition, the over-current protection mechanism or other associated circuitry may limit (e.g., shut down or turn off) the operation of the component to protect the component and/or the circuit in which the component resides.

### BRIEF DESCRIPTION OF THE DRAWINGS

FIG. 1 is a block diagram of an example prior art switching circuit.

FIG. 2 is a block diagram of an example protection device to detect an over-current condition.

FIG. 3 is a schematic diagram of an example circuit implementation of an example protection device.

FIG. 4 illustrates an example process to detect an over-current condition.

FIG. 5 illustrates an example communication device in which the example protection device of FIG. 3 may be implemented.

### DETAILED DESCRIPTION

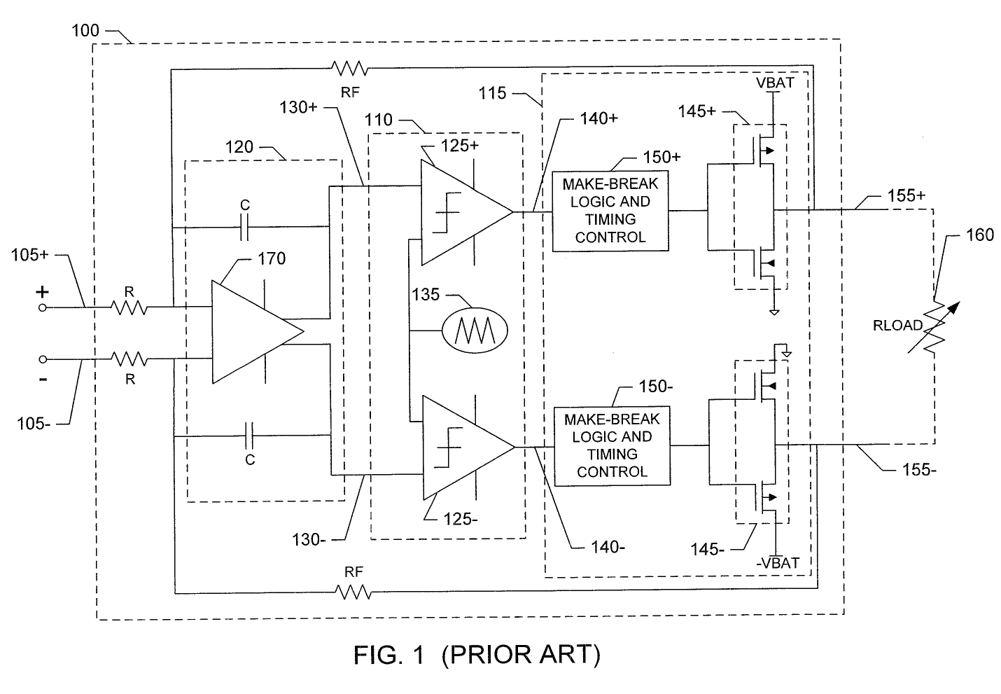

Switching circuits (e.g., switching amplifiers or regulators) typically include an output stage (e.g., the output stage 115 of FIG. 1) that includes one or more components (e.g., the power FET arrays 145+ and 145− of FIG. 1) that are susceptible to excessive currents (i.e., an over-current condition). Such an over-current condition may be caused by the inadvertent shorting of a circuit output, the coupling of a load having a lower resistance than the load for which the circuit was designed, a malfunctioning of output devices due to latch up (i.e., the inadvertent creation of a low-impedance path between the power supplies rails of a component), or any other condition that may cause a large current demand to be presented at the output stage of the switching circuit. The susceptible components can become disabled or damaged if a peak current is exceeded. Such a peak current may be a known value, may be calculated or determined through testing, etc.

To protect against such excessive currents, sensors may be coupled to the circuit (e.g., operatively connected to the susceptible components) to detect or measure a value (e.g., a voltage, current, impedance, etc.) associated with the output stage and/or the components of the output stage. Information gathered by the sensors may be compared to a known threshold value to determine if a predetermined limit has been exceeded. Where the measured condition exceeds the predetermined limit, a signal may be generated to indicate the presence of an over-current condition (i.e., any condition which may cause damage to the components or the circuit in which the components reside).

However, such measurements and/or comparisons may not be accurate, resulting in erroneous indications regarding the status of the output stage. For example, size differences (i.e., size ratios) between a component (e.g., a current carrying transistor of an output stage of a class-D amplifier) and an associated sensor (e.g., a sense transistor placed among the fingers of a susceptible FET) may cause a mismatch between the sensor readings and the component readings. Spatial gradients on the chip on which the components and sensors reside may also cause mismatches. Generally, any imprecision associated with the components and/or other aspects of the circuit may lead to an inaccurate detection of an over-current condition.

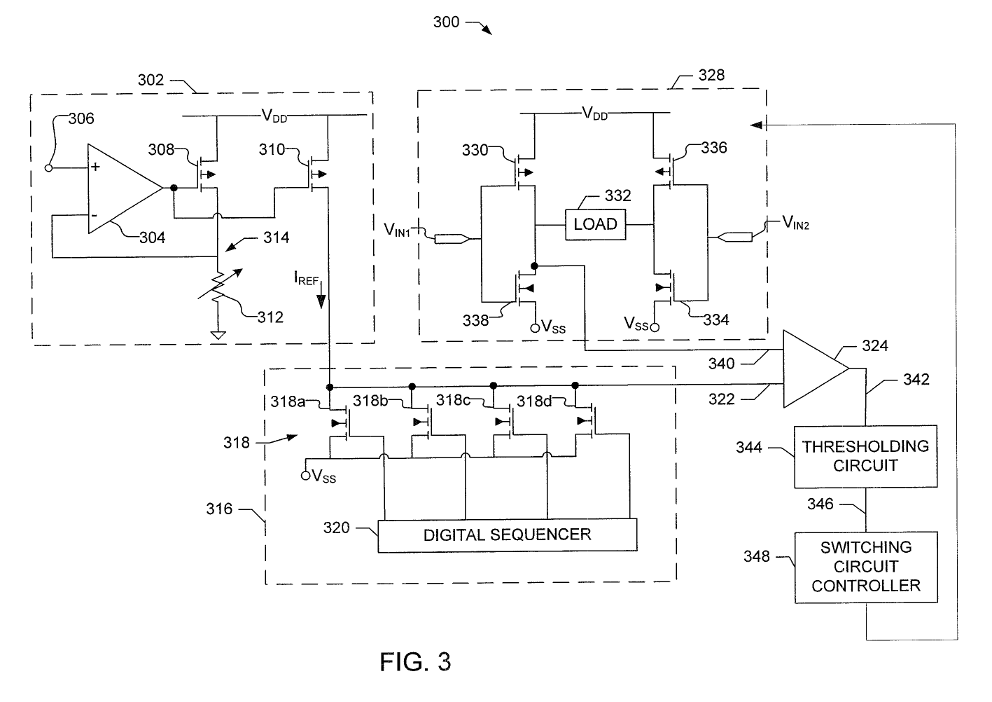

The methods and apparatus described herein provide an accurate protection system to avoid the problems associated with an over-current condition in a switching circuit, such as a switching power supply or amplifier. For example, the methods and apparatus described herein may be implemented in a class-D, push-pull amplifier. A class-D amplifier is an example switching circuit that converts an input signal to a pulse width modulation (PWM) signal that may be amplified efficiently by output stage transistors (e.g., the transistors 330, 334, 336, and 338 of the output stage 328 of FIG. 3) configured and controlled to operate as switches. The amplified PWM signal generated by the class-D amplifier may then be filtered to produce an amplified version of the original input signal. Class-D amplifiers are particularly suited for the amplification of audio signals due to the tolerance of audio signals to phase variations.

FIG. 1 is a block diagram of an example class-D amplifier circuit 100. The example class-D amplifier circuit 100 is configured to operate on analog differential inputs 105+, 105− and includes a PWM generator 110, an output stage 115 and a feedback integration stage 120. The PWM generator 110 implements differential PWM generation and includes comparators 125+, 125− to compare the PWM generator differential inputs 130+, 130− with an output of a ramp generator 135 to generate the PWM generator differential outputs 140+, 140−. The PWM generator differential outputs 140+, 140− are coupled to the output stage 115 for amplification. The output stage 115 includes power FET arrays 145+, 145− that are controlled by make-break logic and timing control circuits 150+, 150− such that the power FET arrays 145+, 145− operate in either a completely switched ON state or a completely switched OFF state. The FET arrays 145+, 145− are switched ON or OFF according to whether a pulse is present or absent, respectively, on the PWM generator differential outputs 140+, 140−. Furthermore, the FET arrays 145+, 145− are directly coupled to the battery voltage (VBAT) and, thus, the class-D amplifier circuit 100 supports a direct battery connection. The FET array outputs form the differential outputs 155+, 155− of the example class-D amplifier circuit 100 and may be coupled to a load 160 in a bridge-tied load (BTL) configuration as shown in FIG. 1.

The differential outputs 155+, 155− are also fed back as inputs to the integration stage 120. The integration stage 120 includes an integration amplifier 170 to implement a first-order feedback loop having a bandwidth that suppresses non-linear distortions caused by switching of the FET arrays 145+, 145− and/or operation of the ramp generator 135, and/or that suppresses noise and ripple from the power supply driving the example class-D amplifier circuit 100. Although the circuit 100 of FIG. 1 includes a first-order feedback loop, class-D devices or other switching circuits may implement one or more loops of a higher order (e.g., a second-order or third-order feedback loop). As is known from delta-sigma converter theory, employing an integrator before a noise adding element and then feeding back the inverse of the circuit output to the input of the integrator pushes the noise effects higher up in the frequency band. In the case of audio signals applied to the analog differential inputs 105+, 105−, an external low pass filter may be used to filter out the noise effects and extract the amplified audio signal. In much the same manner, the feedback loop implemented using the integration stage 120 thereby improves the total harmonic distortion (THD) and power supply rejection ratio (PSRR) associated with the prior art class-D amplifier circuit 100.

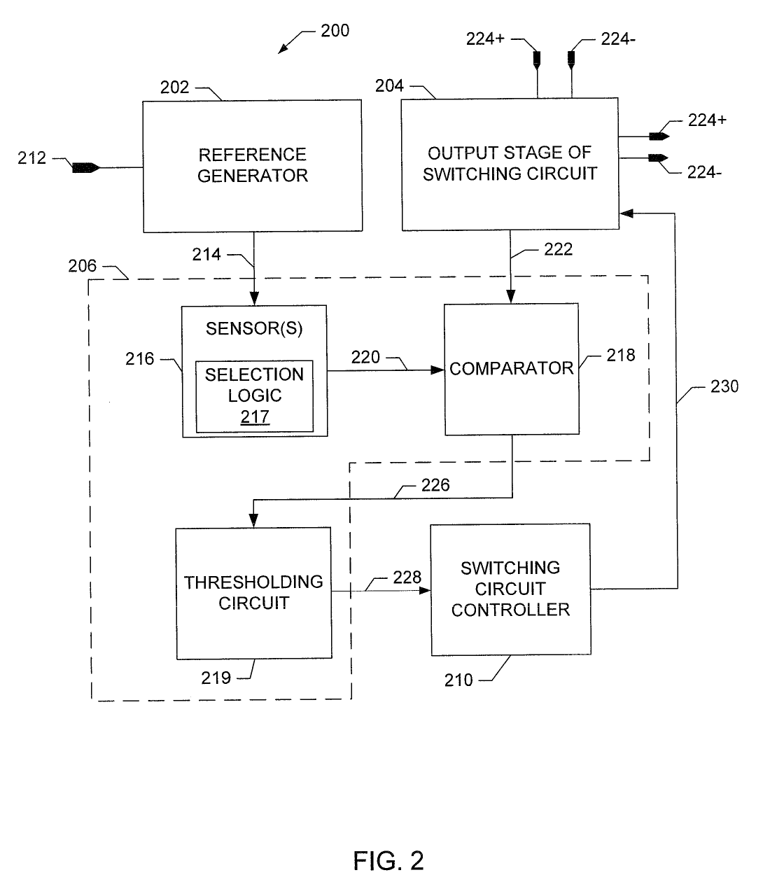

FIG. 2 is a block diagram of an example protection device 200 to protect against excessive currents in a switching circuit. The protection device 200 may be implemented in connection with, for example, the class-D amplifier 100 of FIG. 1. More specifically, in one example, the protection device 200 may detect and/or respond to an over-current condition in one or more of the transistors of the FET arrays 145+ and 145− of FIG. 1. The protection device 200 may include a reference generator 202 and a threshold detector 206, which may be coupled to an output stage 204 of the switching circuit and a switching circuit controller 210.

Generally, the reference generator 202 provides a reference signal 214 that indicates a peak current, above which a fault should be declared. The reference generator 202 may receive an input 212 to generate the reference signal 214 (e.g., a reference current or voltage) based on circuit or component characteristics (e.g., load resistance, impedance, etc.). The input 212 may be a band gap reference voltage. Such a band gap reference provides a temperature-independent reference voltage that is typically stable. As described below in connection with FIG. 3, the reference signal may be adjusted (e.g., via an adjustable resistor) to conform to varying circuit aspects (e.g., varying amounts of sensors as described below). In other words, the reference signal 214 may be adjusted to correspond to a value that indicates the peak current (e.g., the maximum current that does not damage the associated component). The reference signal 214 may then be conveyed to the threshold detector 206, which may include one or more sensors 216, sensor selection logic 217, a comparator 218, and an thresholding circuit 219. The sensor selection logic 217 may determine (e.g., via a randomization process, a systematic process, a pseudorandom process, etc.) one or more of the sensors 216 to which the reference signal 214 may be conveyed. A reading (e.g., a drain-to-source voltage across a sense transistor as described in connection with FIG. 3) may be taken from the selected sensor(s) and a corresponding reference signal 220 may be conveyed to the comparator 218. By providing a plurality of sensors that may be selected, the protection device 200 alleviates possible problems caused by, for example, varying current densities or other variances in circuit components or design. In other words, distributing multiple sensors in an even topology among, for example, the fingers of a FET, multiple readings may be taken to decrease the adverse effects of a mismatched or otherwise imprecisely configured sensor.

The comparator 218 also receives a signal 222 from the output stage 204 of the switching circuit for which the protection device 200 is implemented. As described above in connection with FIG. 1, the output stage 204 may receive pulse width modulated inputs 224+ and 224− (e.g., the outputs of the make-break logic and timing control stages 150+ and 150− of FIG. 1). The inputs 224+ and 224− may cause a current to flow through, for example, output transistors (e.g., the FET arrays 145+ and 145− of FIG. 1) that may be susceptible to excessive current. The output stage 204 may also include outputs 232+ and 232− (e.g., the differential outputs 155+, 155− of FIG. 1) that are coupled to a load (e.g., the load 160 of FIG. 1). Generally, the protection device 200 may take a reading (e.g., a drain-to-source voltage as described in connection with FIG. 3) from such a transistor and the corresponding signal 222 may be conveyed to the comparator 218.

To determine whether a peak current has been exceeded, the comparator 218 may compare the signal 220 from the sensor(s) 216 to the signal 222 from the output stage 204. The sensor(s) 216 are configured to produce a signal (e.g., a reference drain-source voltage) that represents the peak current that may flow through the output stage 204 without causing damage to the components. Thus, where the signal 222 from the output stage 204 exceeds or falls below the signal 220 from the sensors 216, the comparator 218 may generate an indicator signal 226 (e.g., a logical high signal) to indicate that the peak current for the components of the output stage 204 has been exceeded.

The indicator signal 226 (e.g., the logical high or low signal) from the comparator 218 may be conveyed to a thresholding circuit 219 (e.g., an individual level averaging circuit), which may include a storage device (e.g., a register) to track the results of the comparator 218. The thresholding circuit 219 may be configured to take a set of readings from the storage device to determine whether a predetermined amount or percentage of comparisons resulted in an indicator signal 226 indicating that an over-current condition exists (e.g., a logical high signal). For example, where an N-bit register is used to store the results from the comparator 218, the protection device 200 may determine that an over-current condition exists where M of the N bits are set to high. The protection device 200 (e.g., via the thresholding circuit 219) may employ any variety of alternative schemes or algorithms to determine whether a true over-current condition exists. Further, the thresholding circuit 219 may determine a confidence value depending on a likelihood that the signal is an accurate indication of the status of the output stage 204.

The thresholding circuit 219 may generate an over-current signal 228 to indicate whether an over-current condition was detected. In some examples, the over-current signal 228 may include a confidence factor based on a likelihood of accuracy. The over-current signal 228 may be conveyed to the switching circuit controller 210, which is coupled to the output stage 204. The switching circuit controller 210 may generate an output signal 230 to limit or enable the operation of the switching circuit that the protection device 200 is configured to protect. For example, where the thresholding circuit 219 indicates (e.g., via the over-current signal 228) that an over-current condition is present, the output signal 230 may cause operation of the switching circuit to cease, thereby restricting current from flowing to the output stage 204 and the susceptible components therein.

FIG. 3 is a schematic diagram of an example circuit 300 implementation of the example protection device 200 of FIG. 2. Block 302 represents an example implementation of the reference generator 202 of FIG. 2. Specifically, the positive terminal of an operational amplifier (op-amp) 304 receives a band gap reference voltage 306. The output of the op-amp 304 is connected to the gate of first and second PMOS transistors 308 and 310, respectively. The source of each PMOS transistor 308 and 310 is coupled to V_{DD} (e.g., a power supply). The drain of the first transistor 308 is coupled to ground via an adjustable resistor 312. As will be appreciated, by applying the band gap reference voltage to the positive terminal of the op-amp 304, the negative terminal is forced to have a substantially equal voltage as the positive terminal. Thus, the op-amp 304 forces the gate-source voltage of the first PMOS transistor 308 such that node 314 has a voltage substantially equal to the band gap reference voltage 306.

The adjustable resistor 312 may be adjusted to draw a predetermined amount of current from the drain of the first transistor 308. For example, the adjustable resistor 312 may be scaled down to draw a higher current or scaled up to draw a lower amount of current. Thus, the adjustable resistor 312 may be adjusted to cause the generated reference to produce a current corresponding to the peak current that may flow through the output stage components. The second transistor 310 is configured to mirror the current flowing through the first transistor 308 (i.e., as determined by the op-amp 304 and the adjustable resistor 312). The current flowing through the second transistor 310 may then be used as a reference current (I_{REF}). Additionally, to ensure matching, the adjustable resistor 312 may be of a similar type to that of a system-on-chip current reference. Further, EEPROM (electrically erasable programmable read-only memory) trim bits of a system-on-chip current reference may be re-used in the adjustable resistor 312, thereby increasing the efficiency of the circuit and eliminating the need for additional components.

The reference current I_{REF} may be conveyed to block 316, which represents an example implementation of the array of sensors 216 of FIG. 2. In this example, the sensors 318 are implemented as a plurality of NMOS transistors 318a-d. The plurality of sensors 318 enable an increase in the accuracy of the detections and comparisons made therewith. For example, because a sensor may be affected by various factors (e.g., size, doping variations, spatial gradients), inaccuracies may result at individual sensors. However, the protection device 300 compensates for such a problem by taking multiple readings from multiple sensors, thereby decreasing the adverse effects of one or more mismatched sensors. Thus, the example circuits described herein may include sensors 318 evenly distributed among the output stage components of the switching circuit that is being protected. Further, while the example implementation of FIG. 3 includes four sensors, the amount of sensors may be increased (at the cost of additional components) to increase confidence in the results. Block 316 includes four transistors for illustrative purposes and it will be appreciated that alternative amounts of sensors may be used.

The drain of each of the sensors 318 is connected to the reference current I_{REF} and the source of each of the sensors 318 is connected to V_{SS}, which may be the same ground potential to which the adjustable resistor 312 is connected. A digital sequencer 320 is operatively coupled to the gate of each of the sensors 318. In some examples, the digital sequencer may use a signal (e.g., an input or output) from the pulse-width modulator (as described above) as a clock signal. The digital sequencer 320 may send a signal to one of the sensors 318 to allow current to flow through the sensor (e.g., sensor 318a). In other words, the digital sequencer 320 implements a selection of one of the sensors 318a-d, while the remainder of the sensors 318a-d (i.e., the unselected sensors) do not conduct current. Thus, at any given time, current flows through one of the sensors 318. The signal sent to the selected sensors (i.e., to the gate of the selected sensor) may be a voltage required to drive the gate of the selected sensor at a maximum current sourcing capacity. In other words, the signals sent from the digital sequencer 320 may be either a maximum gate voltage or a zero voltage signal. As the reference current I_{REF} flows through the selected sensor, a reference voltage 322 is sensed from the drain of the selected sensor. The reference voltage 322 is associated with the peak current described above. In other words, the aspect ratios of the sensors to the output stage components is set such that where a peak current flows through the output stage component, the reference voltage 322 is substantially equal to the voltage reading 340 (described below) taken from the output stage 328. Accordingly, the reference voltage 322 is conveyed to a comparator 324 to be compared to a signal from the output stage 328. Further, the voltage 322 may conveyed to a switch before reaching the comparator 324 such that the comparison described herein selectable occurs where the component being protected (e.g., transistor 338) is on or conducting current. Thus, where the voltage reading 340 exceeds or falls below the reference voltage 322, an over-current condition may be detected.

Further, the digital sequencer 320 may randomly select one of the sensors 318a-d to compensate for possible systematic errors or other errors associated with the production of the chip. Generally, different components on the chip may have mismatched properties. For example, sensor 318b may have been incorrectly manufactured (e.g., fabricated) or may be affected by an uneven current density throughout the chip due to its location (e.g., among the fingers of a FET). As described above, errors may also occur from spatial gradients on the chip or size differences between current carrying transistors and the sense transistors. Thus, a selection (e.g., a random or sequential selection) of one of the plurality of sensors 318a-d enables the circuit 300 to produce more accurate over-current detection signals. In other words, the inaccuracies that may be caused by mismatched properties of certain components may avoided or alleviated by including a plurality of sensors from which several readings may be taken. Further, a thresholding calculation (e.g., an averaging or majority-based calculation) involving multiple over-current detection signals (resulting from readings taken from randomly selected sensors) may increase the accuracy of the detection comparisons.

The output stage 328 represents an example circuit implementation of the output stage 204 of the switching circuit of FIG. 2. The output stage 328 operates in a substantially similar manner as the output stage 115 of FIG. 1 and, thus, is not described in detail. Generally, at any given time, current may flow in one of two paths. The selected path is determined by two inputs V_{IN1} and V_{IN2}. Specifically, current may flow from the power supply V_{DD}, through transistor 330, through a load 332, through transistor 334, and to ground V_{SS} (e.g., the same ground as coupled to the sensors 318 of block 316). Alternatively, on a half-cycle with different polarity, current may flow from the power supply V_{DD}, through transistor 336, through the load 332, through transistor 338, and to ground V_{SS}. In the example circuit 300 of FIG. 3, transistor 338 is being protected from an over-current condition. To detect such an over-current condition, a drain-source voltage reading 340 is taken from the drain of transistor 338 and conveyed to the comparator 324. Further, a level shifter may be employed to alter the level of the readings 322 and 340 if necessary for the proper operation of the comparator 324.

The reference current I_{REF} produced by the reference generator 302 produces a drain-source voltage in one of the sensors 318a-d. Current flowing through transistor 338 also produces a drain-source voltage across transistor 338. The sensors 318a-d are constructed or configured such that the reference current I_{REF} produces a drain-source voltage across the selected sensor (e.g., 318b) substantially similar to the drain-source voltage across transistor 338 produced by a peak current flowing through the output stage 328. Thus, a comparison between the drain-source voltages of the selected sensor (e.g., sensor 318b) and transistor 338 are represent a comparison between the currents flowing through the selected sensor (e.g., sensor 318b) and transistor 338.

The comparator 324 may be implemented by any variety of voltage comparison devices. Generally, the comparator 324 may generate a signal 342 (e.g., a high or low signal) to indicate whether the voltage 340 from the output stage 328 exceeds or falls below the reference voltage 322 generated by the components of block 302 and block 316. As described above, such an indicator signal 342 may be conveyed to a thresholding circuit 344 for storage and/or further processing (as described above in connection with FIG. 2). For example, the thresholding circuit 344 may take a predetermined amount of stored comparison results, average the results, and generate an over-current signal 346. In other examples, the thresholding circuit 344 may implement a majority-based algorithm to generate the over current signal 346. Further, as described above in connection with FIG. 2, the over-current signal 346 may be conveyed to a switching circuit controller 348 to control and/or limit the operation of the switching circuit that the circuit 300 is configured to protect, thereby preventing damage to any components that may be susceptible to large current demands.

While the circuit 300 of FIG. 3 is configured to detect values (e.g., currents, voltages, etc.) associated with transistor 338, similar or additional circuits may be implemented to detect values associated with other components of the switching circuit (e.g., transistors 330, 334, or 336 of the output stage 328). For example, transistor 334 may also be coupled to a comparator (e.g., a comparator similar to the comparator 324) to detect an over-current condition. In other words, additional circuitry may be added or included in the circuit 300 to ensure protection of all of the components of the output stage 328.

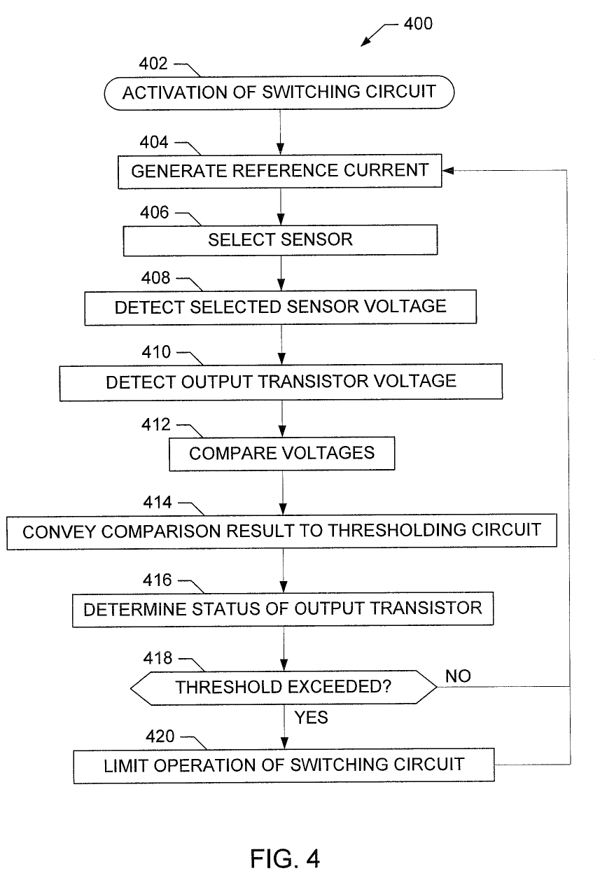

FIG. 4 illustrates an example process 400 to detect an over-current condition using the methods and apparatus described herein. The process 400 may be implemented using hardware, such as the hardware described above, or using hardware in conjunction with software. For example, portions of the process 400 may be performed by any form of logic. Logic may include, for example, implementations that are made exclusively in dedicated hardware (e.g., analog and/or digital circuits, transistors, logic gates, hard-coded processors, programmable array logic (PAL), application-specific integrated circuits (ASICs), etc.), exclusively in software, exclusively in firmware, or some combination thereof. Furthermore, while the following process is described and shown in a particular order, those having ordinary skill in the art will readily recognize that such an ordering is merely one example and numerous other orders exist. Accordingly, while the following describes example processes, persons of ordinary skill the art will readily appreciate that the examples are not the only way to implement such processes.

The process 400 may be performed upon the activation of a switching circuit (e.g., the class-D amplifier 100 of FIG. 1) (block 402). The process 400 may generate a reference current (e.g., I_{REF} of FIG. 3) to be conveyed to a plurality of sensors (e.g., the sensors 318 of FIG. 3) (block 404). The reference current may be generated to correspond to a peak current value, which may be a known current value that, when exceeded, may cause damage to a component. The process 400 may select (e.g., randomly, pseudo-randomly, systematically, or otherwise) a sensor from a plurality of sensors to receive the reference current (block 406), and may detect a voltage (e.g., a drain-source voltage of a FET) across the selected sensor (block 408). The plurality of sensors may be configured to have similar characteristics as the components that the process 400 is protecting. In one example, the plurality of sensors may be a set of sense transistors distributed among the fingers of a power FET of an output stage of the switching circuit. The sensors may be distributed in varying positions to improve the accuracy of the readings described herein (i.e., to avoid problems caused by uneven current density).

The process 400 may also detect a voltage (e.g., a drain-source voltage of a power FET) associated with a component of the output stage of the switching circuit that may be susceptible to an over-current condition (block 410). Both detected voltages may then be compared via a voltage comparator (block 412). Where the voltage detected from the susceptible component of the output stage exceeds or falls below, for example, the voltage detected from the selected sensor, the comparator may convey a message to a thresholding circuit, which may include a storage device to store the results sent by the comparator (block 414). The thresholding circuit may employ one or more algorithms to determine whether (and perhaps a confidence level) an over-current condition exists (block 416). For example, the thresholding circuit may determine whether a majority of comparisons resulted in an over-current condition indication (e.g., a high signal generated by the comparator). Where the threshold or peak current is exceeded (block 418), a controller operatively coupled to the thresholding circuit may limit the operation of the switching circuit (block 420), thereby protecting the susceptible component from a damaging current demand.

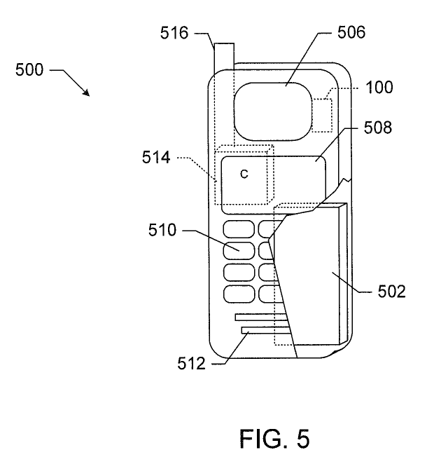

Generally, the example methods and apparatus described herein may utilize a plurality of evenly distributed sensors to accurately detect an over-current condition. Further, results may be averaged over time to increase the confidence in an indication of an over-current condition. FIG. 5 illustrates an example environment in which the methods and apparatus described herein may be implemented. Specifically, an example wireless communication device 500 is illustrated that may include the protection device 200 of FIG. 2. The example wireless communication device 500 may be a mobile telephone (e.g., a cell phone, a wireless messaging device, etc.), a pager, a laptop computer, a wireless game device, an MP3 player, etc. The example wireless communication device 500 includes a processor 502 (e.g., general purpose programmable processor), a ground-reference audio amplifier 100, a display 508, a plurality of keys (e.g., buttons) 510, and a microphone 512, all of which may be communicatively coupled to the example processor 502. The processor 502 includes a local memory, and executes coded instructions present in the local memory and/or in another memory device. The processor 502 may be any type of processing unit, such as one or more microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

In the illustrated example, the wireless communication device 500 includes a speaker 506 that is communicatively coupled to the example processor 502 via an audio amplifier (e.g., the amplifier 100 of FIG. 1), which may include the over-current protection methods and apparatus described herein. The example wireless communication device 500 also includes a wireless communication transceiver 514 that is communicatively coupled to an antenna 516. The wireless communication transceiver 514 may be implemented using, for example, WiMAX technology, wireless Ethernet technology (e.g., 802.11(b), etc.), CDMA technology, TDMA technology, GSM technology, analog/AMPS technology, Wireless USB technology, and/or any other suitable past, present or future mobile communication technology. Then example processor is communicatively coupled to the wireless communication transceiver 514 to selectively use the wireless communication transceiver 514 to, for example, communicate with a wireless base station (not shown). The wireless communication device 500 of the illustrated example also includes other electronics hardware such as, for example, a Bluetooth® transceiver and/or an 802.11 (i.e., Wi-Fi®) transceiver, either of which may be communicatively coupled to the example processor 502.

Finally, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to detect an over-current in a switching circuit comprising:
selecting a sensor from a plurality of sensors operatively coupled to an output stage of the switching circuit;
detecting a first voltage via the selected sensor;
detecting a second voltage of a component of the output stage; and
comparing the first voltage to the second voltage to generate a signal, wherein the signal indicates a status of the output stage of the switching circuit.

2. A method as defined in claim 1, wherein selecting the sensor from the plurality of sensors comprises a random selection.

3. A method as defined in claim 1, further comprising limiting an operation of the switching circuit where the signal indicates an over-current status of the output stage.

4. A method as defined in claim 1, further comprising conveying the signal to an thresholding circuit and generating a control signal, via the thresholding circuit, to control an operation of the switching circuit.

5. A method as defined in claim 1, further comprising using a digital sequencer to select one or more sensors from the plurality of sensors.

6. A method as defined in claim 5, wherein the digital sequencer uses an input of a pulse-width modulator of the switching circuit as a clock.

7. A method as defined in claim 1, wherein detecting a first voltage via the selected sensor comprises generating a reference current and conveying the reference current to the plurality of sensors.

8. A method as defined in claim 7, wherein the reference current is generated via a band gap reference voltage.

9. A method as defined in claim 7, wherein generating the reference current further comprises adjusting an adjustable resistor via system-on-chip EEPROM trim bits.

10. A method as defined in claim 1, wherein the plurality of sensors comprises field-effect transistors.

11. A method as defined in claim 1, wherein the first and second voltages comprise a drain-source voltage of a field-effect transistor.

12. An apparatus for use in a switching circuit to detect an over-current comprising:
a plurality of sensors operatively coupled to an output stage of the switching circuit;
a selector to select a sensor from the plurality of sensors;
a comparator to generate a signal based on a comparison of a first voltage and a second, wherein the first voltage is detected by the selected sensor and the second voltage is associated with a component of the output stage; and
wherein the signal indicates a status of the output stage of the switching circuit.

13. An apparatus as defined in claim 12, further comprising a digital sequencer to randomly select the sensor from the plurality of sensors.

14. An apparatus as defined in claim 12, further comprising a controller to limit an operation of the switching circuit where the signal indicates an over-current status of the output stage.

15. An apparatus as defined in claim 12, further comprising an thresholding circuit to receive the signal, wherein the thresholding circuit generates a control signal to control an operation of the switching circuit.

16. An apparatus as defined in claim 12, further comprising a reference generator to generate a reference current to be conveyed to the plurality of sensors.

17. An apparatus as defined in claim 12, wherein the plurality of sensors comprises field-effect transistors.

18. An apparatus as defined in claim 12, wherein the switching circuit includes one of a switching amplifier, a voltage regulator, or a class-D amplifier.

19. A circuit to detect an over-current comprising:
a plurality of sensors operatively coupled to an output stage of a switching circuit;
a digital circuit configured to randomly select a first sensor and a second sensor from the plurality of sensors;
a comparator to generate a first signal and a second signal,
wherein the first signal is based on a comparison of a first reference voltage detected by the first sensor and a first voltage associated with a component of the output stage,
wherein the second signal is based on a comparison of a second reference voltage detected by the second sensor and a second voltage associates with the component of the output stage,
wherein the first signal and the second signal indicate a status of the output stage of the switching circuit; and
an thresholding circuit to receive the first signal and the second signal, wherein the thresholding circuit generates a control signal to control an operation of the switching circuit.

20. A circuit as defined in claim 19, wherein the first sensor and the second sensor comprise the same sensor.
